(19) United States
(12) Patent Application Publication
(10) Pub. No.: US 2008/0200123 A1
(43) Pub. Date: Aug. 21, 2008

(54) Mobile Phone, Wireless Transmission System, and Related Method Capable of Auto-Adjusting Call Alarms

(76) Inventors: Chun-Yu Lin, Taichung County (TW); Hsien-Chung Lin, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/031,720

(22) Filed: Feb. 15, 2008

(30) Foreign Application Priority Data
Feb. 16, 2007 (TW) 096106275

(51) Int. Cl. H04B 7/00

(52) U.S. Cl. 455/41.3

(57) ABSTRACT

A mobile phone capable of auto-adjusting call alarms collocates with a wireless transmission device that is separated from the mobile phone and can be carried by a user. The mobile phone includes a receiving device and a processing unit. The receiving device is used for receiving signals transmitted from the wireless transmission device. The processing unit is coupled to the receiving device for determining a distance between the wireless transmission device and the receiving device and for determining call alarms of the mobile phone according to the distance between the wireless transmission device and the receiving device. The processing unit sets the call alarms of the mobile phone to a preset alarm mode when the processing unit determines that the distance between the wireless transmission device and the receiving device is greater than a predetermined distance.

### BACKGROUND OF THE INVENTION

1. Field of the Invention

The invention relates to a mobile phone, a wireless transmission system, and related method capable of auto-adjusting call alarms, and more particularly, to a mobile phone determining the call alarms by judging a distance between the mobile phone and a wireless transmission device.

2. Description of the Prior Art

Owing to the rapid development of wireless communication systems, a handy communication device of great convenience is widely used in daily communications. With convenient communication devices, people are able to exchange information, share experiences, and communicate with each other anytime and anywhere. Due to the popularity of communication devices, it is not surprising system owners or mobile manufacturers are devoted to seeking more convenient operations or to provide more friendly communication services.

Generally speaking, when local call phones or mobile phones have an incoming call, a telephone ring notice is used for notifying users of the incoming call. However, in certain occasions such as at a meeting or some ceremonies, the telephone ring notice will cause the users and even other people much trouble. For example, a common condition recently is that the users are not nearby but the telephone ring of the mobile phone is loud. In addition, due to no one responding to the mobile phone, the calling party keeps making many calls. Sometimes, no matter how loud the telephone ring is, the users cannot hear it and the ring only causes other people much trouble.

### SUMMARY OF THE INVENTION

It is an objective of the present invention to provide a mobile phone and related method capable of auto-adjusting call alarms.

According to an embodiment of the present invention, a mobile phone capable of auto-adjusting call alarms is disclosed. The mobile phone is used together with a wireless transmission device that is separated from the mobile phone and can be carried by a user. The mobile phone includes a receiving device and a processing unit. The receiving device is used for receiving signals transmitted from the wireless transmission device. The processing unit is coupled to the receiving device for determining a distance between the wireless transmission device and the receiving device and for determining call alarms of the mobile phone according to the distance between the wireless transmission device and the receiving device.

According to an embodiment of the present invention, a method capable of auto-adjusting call alarms of mobile phones is disclosed. The method is applied to a wireless communication system that comprises a wireless transmission device and a mobile phone. The wireless transmission being separated from the mobile phone and can be carried by a user. The method includes detecting a distance between the wireless transmission device and the mobile phone, and determining whether the distance between the wireless transmission device and the mobile phone is smaller than a predetermined distance; and determining call alarms of the mobile phone according to whether the distance between the wireless transmission device and the mobile phone is smaller than the predetermined distance.

According to an embodiment of the present invention, a wireless communication system is disclosed. The wireless communication system includes a wireless transmission device and a mobile phone. The wireless transmission device can be carried by a user. The mobile phone is separated from the wireless transmission device and includes a receiving device and a processing unit. The receiving device is used for receiving signals transmitted from the wireless transmission device. The processing unit is coupled to the receiving device for determining a distance between the wireless transmission device and the receiving device and for determining call alarms of the mobile phone according to the distance between the wireless transmission device and the receiving device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a mobile phone capable of auto-adjusting call alarms according to an embodiment of the present invention.

FIG. 2 is a diagram illustrating how to determine the call alarms of the mobile phone in FIG. 1.

FIG. 3 is a diagram of a flow for controlling the call alarms of the mobile phone according to an embodiment of the present invention.

FIG. 4 is a diagram of a flow for controlling the call alarms of the mobile phone according to another embodiment of the present invention.

### DETAILED DESCRIPTION

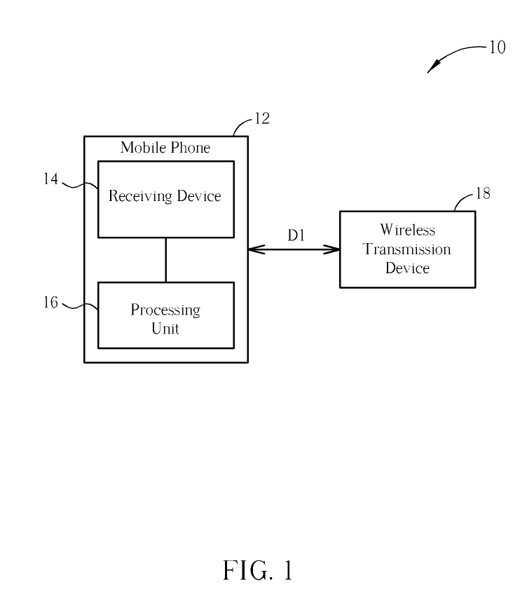

Please refer to FIG. 1. FIG. 1 is a diagram of a mobile phone 12 capable of auto-adjusting call alarms according to an embodiment of the present invention. As shown in FIG. 1, the mobile phone 12 is used together with a wireless transmission device 18 to form a wireless communication system 10. The wireless transmission device 18 is separated from the mobile phone 12 and can be carried by a user. The mobile phone 12 includes a receiving device 14 and a processing unit 16. The processing unit 16 is coupled to the receiving device 1 4 for determining a distance D1 between the wireless transmission device 18 and the receiving device 14 and for determining call alarms of the mobile phone 12 according to the distance D1 between the wireless transmission device 18 and the receiving device 14. The wireless transmission device 18 can be a Bluetooth headset or a radio frequency identification (RFID) that is worn on user's person.

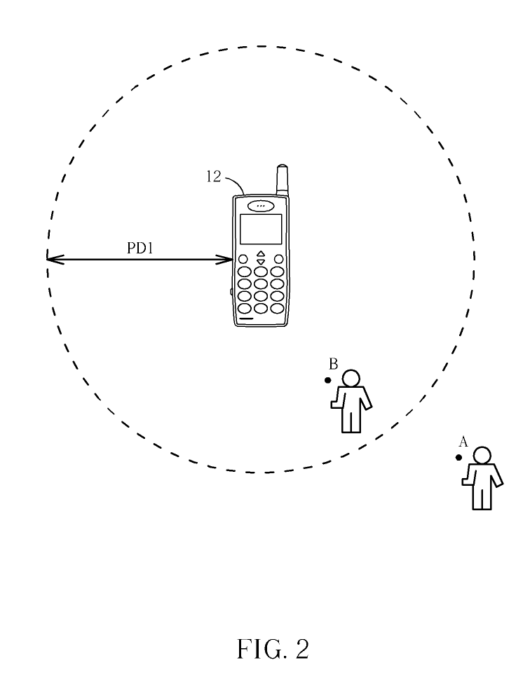

Please refer to FIG. 2 and FIG. 1. FIG. 2 is a diagram illustrating how to determine the call alarms of the mobile phone 12 in FIG. 1. Assume that a present alarm mode of the mobile phone 12 is a second designated alarm mode CAM2, such as a general telephone ring. When the user (the wireless transmission device 18) is originally located at a first location A, at this time, the distance D1 between the wireless transmission device 18 and the mobile phone 12 is greater than a predetermined distance PD1. Then the processing unit 16 will set the call alarms of the mobile phone 12 to a first designated alarm mode CAM1. When the user is located at a second location B, the distance D1 between the wireless transmission device 18 and the mobile phone 12 is smaller than the predetermined distance PD1. At this time, the processing unit 16 will set the call alarms of the mobile phone 12 to the original second designated alarm mode CAM2. If the user moved from the first location A to the second location B and the mobile phone 12 received an incoming call before moving to within the predetermined distance PD1, the mobile phone will generate a notice (such as flashlight) to notify the user of the non-received incoming call. In addition, the first designated alarm mode CAM1 can be a vibration mode, a flashlight mode, or a quiet mode. Therefore, the call alarms of the mobile phone 12 can be auto-adjusted for not bothering other people if the user (the wireless transmission device 18) is not near the mobile phone 12 (not smaller than the predetermined distance PD1). Besides, the mobile phone 12 may generate the notice to notify the user of the non-received incoming call to prevent from a call miss.

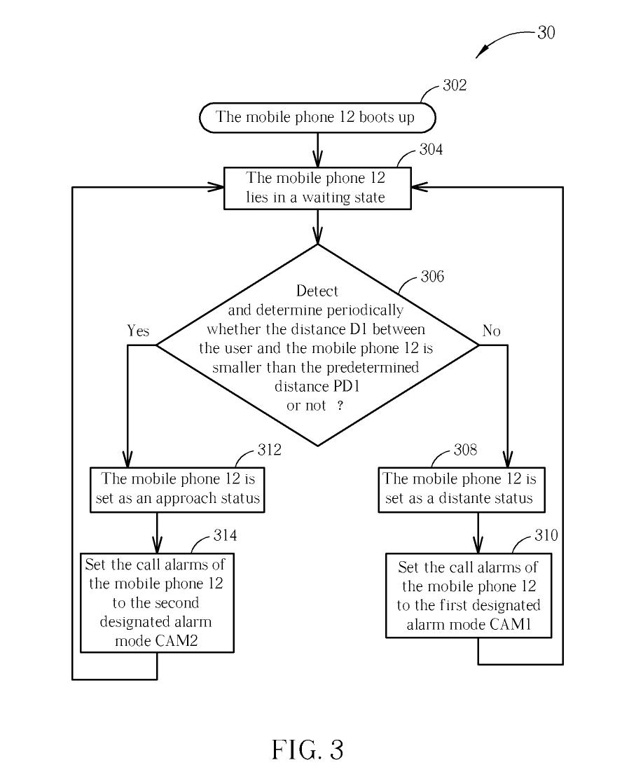

Please refer to FIG. 3, which is a diagram of a flow 30 for controlling the call alarms of the mobile phone 12 according to an embodiment of the present invention. The flow 30 includes the following steps:

Step 302: The mobile phone 12 boots up.

Step 304: The mobile phone 12 lies in a waiting state.

Step 306: Detect and determine periodically whether the distance D1 between the user and the mobile phone 12 is smaller than the predetermined distance PD1. If the distance D1 between the user and the mobile phone 12 is greater than the predetermined distance PD1, the process goes to step 308; otherwise, the process goes to step 312.

Step 308: If the distance D1 between the user and the mobile phone 12 is greater than the predetermined distance PD1, the mobile phone 12 is set as a distance status.

Step 310: Set the call alarms of the mobile phone 12 to the first designated alarm mode CAM1.

Step 312: If the distance D1 between the user and the mobile phone 12 is smaller than the predetermined distance PD1, the mobile phone 12 is set as an approach status.

Step 314: Set the call alarms of the mobile phone 12 to the second designated alarm mode CAM2.

In step 306, the processing unit 16 will determine the call alarms of the mobile phone 12 according to the distance D1 between the user and the mobile phone 12. If the distance D1 between the user and the mobile phone 12 is greater than the predetermined distance PD1, the processing unit 16 will set the mobile phone 12 to the distant status and set the call alarms of the mobile phone 12 to the first designated alarm mode CAM1 (steps 308-310). Oppositely, if the distance D1 between the user and the mobile phone 12 is smaller than the predetermined distance PD1, the processing unit 16 will set the mobile phone 12 to the approach status and set the call alarms of the mobile phone 12 to the second designated alarm mode CAM2 (steps 312-314). In this embodiment, the processing unit 16 periodically detects the distance D1 and auto-adjusts the call alarms of the mobile phone 12.

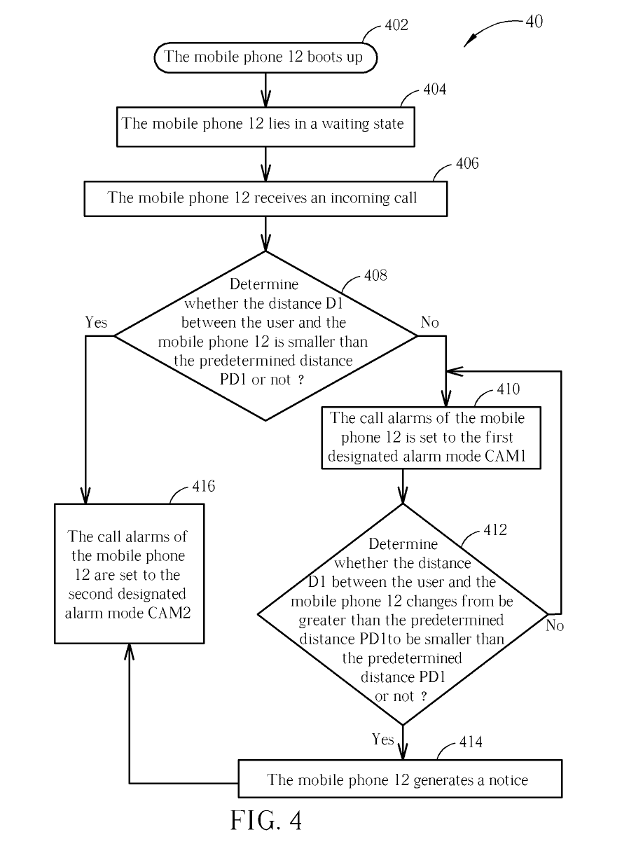

Please refer to FIG. 4, which is a diagram of a flow 40 for controlling the call alarms of the mobile phone 12 according to another embodiment of the present invention. The flow 40 includes the following steps:

Step 402: The mobile phone 12 boots up.

Step 404: The mobile phone 12 lies in a waiting state.

Step 406: The mobile phone 12 receives an incoming call.

Step 408: Determine whether the distance D1 between the user and the mobile phone 12 is smaller than the predetermined distance PD1 or not. If the distance D1 between the user and the mobile phone 12 is greater than the predetermined distance PD1, the process goes to step 410; otherwise, the process goes to step 416.

Step 410: The call alarms of the mobile phone 12 are set to the first designated alarm mode CAM1 if the distance D1 between the user and the mobile phone 12 is greater than the predetermined distance PD1.

Step 412: Determine whether the distance D1 between the user and the mobile phone 12 changes from be greater than the predetermined distance PD1 to be smaller than the predetermined distance PD1. If the distance D1 between the user and the mobile phone 12 is originally determined to be greater than the predetermined distance PD1 and later becomes smaller than the predetermined distance PD1, the process goes to step 414; otherwise, the process goes to step 410.

Step 414: The mobile phone 12 generates a notice.

Step 416: If the distance D1 between the user and the mobile phone 12 is smaller than the predetermined distance PD1, the call alarms of the mobile phone 12 are set to the second designated alarm mode CAM2.

Please note that, the difference between the flow 40 and the flow 30 is described as below. In the flow 40, the processing unit 16 starts to detect and determine whether the distance D1 between the user and the mobile phone 12 is smaller than the predetermined distance PD1 only after the mobile phone 12 receives the incoming call (steps 406-408). Moreover, the processing unit 16 sets the call alarms of the mobile phone 12 to the first designated alarm mode CAM1 (for example, the vibration mode, the flashlight mode, or the quiet mode) if the distance D1 between the user and the mobile phone 12 is greater than the predetermined distance PD1 (step 410); and then the mobile phone 12 will generate a notice (such as flashlight) to notify the user of the non-received incoming call if the distance D1 between the user and the mobile phone 12 changes from be greater than the predetermined distance PD1 to be smaller than the predetermined distance PD1 (steps 412-414). Therefore, a call miss can be prevented. If the distance D1 between the user and the mobile phone 12 is smaller than the predetermined distance PD1, the call alarms of the mobile phone 12 are set to the second designated alarm mode CAM2 (such as a telephone ring).

The flows 30 and 40 shown in FIG. 3 and FIG. 4 are merely embodiments of the present invention, and, as is well known by a person of ordinary skill in the art, suitable variations can be applied to the flows. For example, when an incoming call is received in step 406, the call alarms of the mobile phone 12 can be set according to the last detected result without performing detections anymore. Moreover, in the methods described in FIG. 3 and FIG. 4, the flows 30 and 40 can further include other middle steps.

The abovementioned embodiments are presented merely to describe the present invention, and in no way should be considered to be limitations of the scope of the present invention. The abovementioned wireless transmission device 18 is not limited to a Bluetooth headset or a radio frequency identification only, and wireless transmitters in other types can be adopted. In addition, buckling rings or clamping rings can be installed on the wireless transmission device 18 for being carried on user's person. The predetermined distance PD1 is not restricted to a fixed value, and can be adjusted depending on the types of wireless transmission device 18 and user's demands. Furthermore, the methods described in FIG. 3 and FIG. 4 are merely perfect embodiments of the present invention, and other applications that can reach the same objectives and are conformable to the spirit of the present invention should be considered to be the scope of the present invention. The flows 30 and 40 can further include other middle steps, and, as is well known by a person of ordinary skill in the art, suitable variations can be applied to the flows.

From the above descriptions, the present invention provides a mobile phone and related method capable of auto-adjusting call alarms. The call alarms of the mobile phone are determined through determining the distance between the mobile phone and a wireless transmission device. If the distance D1 between the user and the mobile phone 12 is greater than the predetermined distance PD1, the call alarms will be changed to a vibration mode or a quiet mode through the mobile phone of the present invention. If the distance D1 between the user and the mobile phone 12 changes from be greater than the predetermined distance PD1 to be smaller than the predetermined distance PD1, the mobile phone 12 will generate a notice (such as flashlight) to notify the user of the non-received incoming call. Therefore, not only can an objective of not bothering other people be reached but also can a call miss be prevented.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mobile phone capable of auto-adjusting call alarms, being used together with a wireless transmission device that is separated from the mobile phone and can be carried by a user, the mobile phone comprising:
a receiving device used for receiving signals transmitted from the wireless transmission device; and
a processing unit, coupled to the receiving device, for determining a distance between the wireless transmission device and the receiving device and for determining call alarms of the mobile phone according to the distance between the wireless transmission device and the receiving device.

2. The mobile phone of claim 1, wherein the wireless transmission device is selected from a group consisting of a Bluetooth headset and a radio frequency identification (RFID).

3. The mobile phone of claim 1, wherein:
the processing unit periodically determines whether the distance between the wireless transmission device and the receiving device is smaller than a predetermined distance;
when the processing unit determines that the distance between the wireless transmission device and the receiving device is greater than the predetermined distance, the processing unit sets the call alarms of the mobile phone to a first designated alarm mode; and
when the processing unit determines that the distance between the wireless transmission device and the receiving device is smaller than the predetermined distance, the processing unit sets the call alarms of the mobile phone to a second designated alarm mode.

4. The mobile phone of claim 1, wherein:
the mobile phone triggers the processing unit to determine whether the distance between the wireless transmission device and the receiving device is smaller than a predetermined distance when the mobile phone receives an incoming call; when the processing unit determines that the distance between the wireless transmission device and the receiving device is greater than the predetermined distance, the processing unit sets the call alarms of the mobile phone to a first designated alarm mode; and
when the processing unit determines that the distance between the wireless transmission device and the receiving device is smaller than the predetermined distance, the processing unit sets the call alarms of the mobile phone to a second designated alarm mode.

5. The mobile phone of claim 1, wherein:
when the mobile phone receives an incoming call and the distance between the wireless transmission device and the receiving device is greater than a predetermined distance, the processing unit sets the call alarms of the mobile phone to a first designated alarm mode; and
when the mobile phone receives an incoming call and the distance between the wireless transmission device and the receiving device is smaller than the predetermined distance, the processing unit sets the call alarms of the mobile phone to a second designated alarm mode.

6. The mobile phone of claim 5, wherein when the processing unit determines that the distance between the wireless transmission device and the receiving device is originally greater than the predetermined distance and later becomes smaller than the predetermined distance, then the mobile phone generates a notice to remind the user that the mobile phone has issued the first designated alarm mode if the distance between the wireless transmission device and the receiving device is greater than the predetermined distance.

7. The mobile phone of claim 5, wherein a volume of the first designated alarm mode is smaller than a volume of the second designated alarm mode.

8. The mobile phone of claim 7, wherein the first designated alarm mode comprises a quiet mode or a vibration mode.

9. A method capable of auto-adjusting call alarms of a mobile phone, applied to a wireless communication system that comprises a wireless transmission device and a mobile phone, the wireless transmission being separated from the mobile phone and can be carried by a user, the method comprising:
detecting a distance between the wireless transmission device and the mobile phone, and determining whether the distance between the wireless transmission device and the mobile phone is smaller than a predetermined distance; and
determining call alarms of the mobile phone according to whether the distance between the wireless transmission device and the mobile phone is smaller than the predetermined distance.

10. The method of claim 9, wherein the step of determining call alarms of the mobile phone further comprises:
setting the call alarms of the mobile phone to a first designated alarm mode when the distance between the wireless transmission device and the receiving device is determined to be greater than the predetermined distance; and
setting the call alarms of the mobile phone to a second designated alarm mode when the distance between the wireless transmission device and the receiving device is determined to be smaller than the predetermined distance.

11. The method of claim 10, wherein a volume of the first designated alarm mode is smaller than a volume of the second designated alarm mode.

12. The method of claim 11, wherein the first designated alarm mode comprises a quiet mode or a vibration mode.

13. The method of claim 10, further comprising:
when the distance between the wireless transmission device and the receiving device is originally determined to be greater than the predetermined distance and later becomes smaller than the predetermined distance, generating a notice to remind the user that the mobile phone has issued the first designated alarm mode if the distance between the wireless transmission device and the receiving device is greater than the predetermined distance.

14. The method of claim 9, further comprising:
triggering the processing unit to determine whether the distance between the wireless transmission device and the receiving device is smaller than a predetermined distance when the mobile phone receives an incoming call.

15. The method of claim 9, wherein the step of determining whether the distance between the wireless transmission device and the mobile phone is smaller than the predetermined distance comprises:
periodically determining whether the distance between the wireless transmission device and the receiving device is smaller than a predetermined distance.

16. A wireless communication system, comprising:
a wireless transmission device, able to be carried by a user; and
a mobile phone, separated from the wireless transmission device, the mobile phone comprising:
a receiving device used for receiving signals transmitted from the wireless transmission device; and
a processing unit, coupled to the receiving device, for determining a distance between the wireless transmission device and the receiving device and for determining call alarms of the mobile phone according to the distance between the wireless transmission device and the receiving device.

17. The wireless communication system of claim 16, wherein:
when the mobile phone receives an incoming call and the distance between the wireless transmission device and the receiving device is greater than a predetermined distance, the processing unit sets the call alarms of the mobile phone to a first designated alarm mode; and
when the mobile phone receives an incoming call and the distance between the wireless transmission device and the receiving device is smaller than the predetermined distance, the processing unit sets the call alarms of the mobile phone to a second designated alarm mode.

18. The wireless communication system of claim 17, wherein when the processing unit determines that the distance between the wireless transmission device and the receiving device is originally greater than the predetermined distance and later becomes smaller than the predetermined distance, then the mobile phone generates a notice to remind the user that the mobile phone has issued the first designated alarm mode if the distance between the wireless transmission device and the receiving device is greater than the predetermined distance.

19. The wireless communication system of claim 17, wherein a volume of the first designated alarm mode is smaller than a volume of the second designated alarm mode.

20. The wireless communication system of claim 19, wherein the first designated alarm mode comprises a quiet mode or a vibration mode.
